(19) United States
(12) Patent Application Publication
(10) Pub. No.: US 2022/0017071 A1
(43) Pub. Date: Jan. 20, 2022

(54) SELF-ADAPTIVE ASSISTANCE CONTROL METHOD FOR VEHICLE PASSING CURVE, COMPUTER DEVICE AND STORAGE MEDIUM

(71) Applicant: GUANGZHOU AUTOMOBILE GROUP CO., LTD., GUANGZHOU (CN)

(72) Inventors: XINGTAI MEI, GUANGZHOU (CN); CHENG DENG, GUANGZHOU (CN); CHUANSHUAI MA, GUANGZHOU (CN); CHANGQING LIN, GUANGZHOU (CN); QIN LI, GUANGZHOU (CN); QI ZENG, GUANGZHOU (CN)

(21) Appl. No.: 17/309,476

(22) PCT Filed: Jan. 28, 2019
(86) PCT No.: PCT/CN2019/073382

§ 371 Date: May 28, 2021

(30) Foreign Application Priority Data
Dec. 3, 2018 (CN) 201811463437.3

(51) Int. Cl. B60W 30/045; B60W 30/18; B60W 40/107; B60W 40/109; B60W 10/20; B60W 10/10; B60W 10/06

(52) U.S. Cl. CPC B60W 30/045; B60W 2540/10; B60W 40/107; B60W 40/109; B60W 10/20; B60W 10/10; B60W 10/06; B60W 2520/125; B60W 2520/105; B60W 2710/0666; B60W 2710/18; B60W 2552/15; B60W 2552/40; B60W 2510/205; B60W 2520/14; B60W 2520/10; B60W 2520/12; B60W 2530/10; B60W 2530/20; B60W 2540/12; B60W 30/18145

(57) ABSTRACT

Disclosed are a self-adaptive assistance control device, a computer device and a storage medium for vehicle passing curve. The method comprises: step S10, according to signals from vehicle's sensors, identifying current bend types, and obtaining, corresponding to bend types, a lateral impact degree of the current vehicle according to a lateral acceleration; step S11, obtain an expected longitudinal acceleration based on the lateral impact degree; step S12, according to the expected longitudinal acceleration and a current actual longitudinal acceleration, determining an activation type for current bend assist control; and step S13, according to the activation type, cooperatively controlling an engine torque or/and an ESC braking intensity, so as to realize expected longitudinal control over the vehicle in the road curve.

### CROSS-REFERENCE TO RELATED APPLICATIONS

This application is the 371 application of International Application No. PCT/CN2019/073382, filed Jan. 28, 2019, which is based upon and claims priority to Chinese Patent Application No. 201811463437.3, filed Dec. 3, 2018, the entire contents of which are incorporated herein by reference.

### TECHNICAL FIELD

The present disclosure relates to the technical field of vehicle control, and more particularly, to self-adaptive assistance control method for vehicle passing curve, a computer device and a storage medium.

### BACKGROUND

In the handling of the vehicle, the performance of the turning on bend is very important, and it is closely related to the drivability, comfortably, and safety of the vehicle. However, the current Electronic Stability Controller (ESC) of passenger vehicle only works when the vehicle is in critically instable condition or has already been instability and cannot improve the performance of the vehicle in most turning conditions. It is difficult to achieve better performance only through chassis tuning when most vehicles currently do not use active suspension, therefore, it is necessary to use driving assistance technology to improve the handling and stability of the vehicle when turning, related technology including AHA of Honda and GVC of Mazda. Through the control of driving and braking, the performance of the vehicle on passing curve is improved without adding hardware.

However, there are more or less shortcomings in the tradition for passing curve control. For example, the passing curve control technology used in some examples can determine the comfortable speed based on the map information and the comfortable lateral acceleration of the human body, and then perform the corresponding longitudinal control. It is suitable for use in ACC system, it needs to know the bend information in advance, and the environment perception is more complicated; moreover, it is a strong intervention program, which easily conflicts with the driver's driving intention.

In other vehicle passing curve technologies, it is only suitable for certain types of bends, for example, in U-turn and L-turn (right-angle turn) it would have high control accuracy, but in snaking and single shifting condition, it would have a larger error.

In other vehicle passing curve technologies, the slightly adjusting of the wheel would also cause decelerate, which makes the control too sensitive, and will lead to poor user experience.

### SUMMARY

There are provided a self-adaptive assistance control method for vehicle passing curve, a computer device and a storage medium. The technical solution is as below:

According to a first aspect of the present disclosure, there is provided a self-adaptive assistance control method for vehicle passing curve, comprising:

step S10, identifying current bend types based on signals of vehicle's sensors, obtaining lateral acceleration based on model calculation or measurement corresponding to the bend types, and obtaining lateral impact degree of a current vehicle based on the lateral acceleration;

step S11, obtaining an expected longitudinal acceleration based on the lateral impact degree;

step S12, determining an activation type of current bend assist controlling based on the expected longitudinal acceleration and current actual longitudinal acceleration;

step S13, cooperatively controlling engine torque or/and ESC braking intensity to realize expected longitudinal control of vehicle bends based on the activation type, combined with at least one of current slope types, a road adhesion coefficient, and a driver type.

According to a second aspect of embodiments of the present disclosure, there is provided a computer device, comprising: a memory, a processor and computer programs stored in the memory can be executed by the processor, wherein the processor executes the computer programs can realize following steps:

step S10, identifying current bend types based on signals of vehicle's sensors, obtaining lateral acceleration based on model calculation or measurement corresponding to the bend types, and obtaining lateral impact degree of a current vehicle based on the lateral acceleration

step S11, obtaining an expected longitudinal acceleration based on the lateral impact degree;

step S12, determining an activation type of current bend assist controlling based on the expected longitudinal acceleration and current actual longitudinal acceleration; and

step S13, cooperatively controlling engine torque or/and ESC braking intensity to realize expected longitudinal control of vehicle bends based on the activation type, combined with at least one of current slope types, a road adhesion coefficient, and a driver type.

According to a third aspect of embodiments of the present disclosure, there is provided a computer-readable storage medium, on which computer programs are stored, when the computer programs are executed by a processor, the following steps are performed:

step S10, identifying current bend types based on signals of vehicle's sensors, obtaining lateral acceleration based on model calculation or measurement corresponding to the bend types, and obtaining lateral impact degree of a current vehicle based on the lateral acceleration;

step S11, obtaining an expected longitudinal acceleration based on the lateral impact degree;

step S12, determining an activation type of current bend assist controlling based on the expected longitudinal acceleration and current actual longitudinal acceleration; and

step S13, cooperatively controlling engine torque or/and ESC braking intensity to realize expected longitudinal control of vehicle bends based on the activation type, combined with at least one of current slope types, a road adhesion coefficient, and a driver type.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a application environment diagram which the self-adaptive assistance control method for vehicle passing curve provided in this application can be applied to;

FIG. 2 is a diagram of the connection between the self-adaptive assistance control device of the present disclosure and other controllers in the vehicle;

FIG. 3 is a main flow chart of the self-adaptive assistance control method for vehicle passing curve provided by this application, according to an exemplary embodiment;

FIG. 4 is a flow chart for recognizing a regular bend and a special bend involved in step S10 in FIG. 3;

FIG. 5 is a diagram of the correction of the expected longitudinal acceleration in the special bend in step S12 of FIG. 3;

FIG. 6 is a diagram of the steering wheel threshold involved in bend assist control in step S12 of FIG. 3 when entering a bend;

FIG. 7 is a flow diagram for determining the type of bend activation involved in step S12 in FIG. 3;

FIG. 8 is a block diagram of the self-adaptive assistance control device for vehicle passing curve, according to an exemplary embodiment;

FIG. 9 is a block diagram of the internal structure of an embodiment of the computer device provided by the application.

### DETAILED DESCRIPTION

To make the disclosure purpose, technical solution and advantages clearer. The present disclosure will be described in further detail below in conjunction with the accompanying drawings.

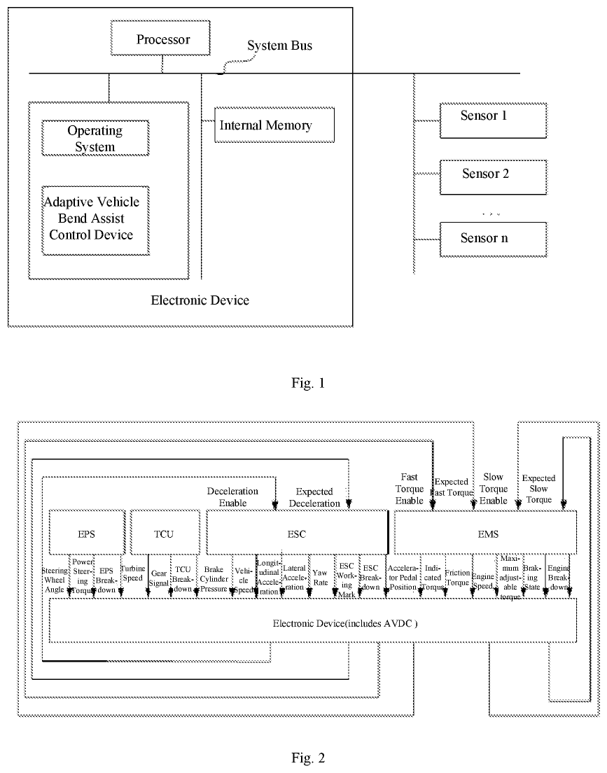

The self-adaptive assistance control method for vehicle passing curve provided in this application can be applied to the application environment as shown in FIG. 1. The electronic device communicates with each sensor through the system bus. The electronic device includes a processor connected through system bus, a non-volatile storage medium, an internal memory, and an input device. The non-volatile storage medium of the electronic device stores an operating system, and further includes a self-adaptive assistance control device for vehicle passing curve. This self-adaptive assistance control device for vehicle passing curve of the electronic device is used to implement a self-adaptive assistance control method for vehicle passing curve. The processor is used to provide calculation and control capabilities and support the operation of the entire electronic device. The internal memory in the electronic device provides an environment for the operation of the self-adaptive assistance control device for vehicle passing curve in the non-volatile storage medium. Specifically, the self-adaptive assistance control device for vehicle passing curve can analyze the driver's handling intention according to the existing sensors of the vehicle, according to the steering wheel, accelerator, and brake pedal, and apply certain longitudinal control according to the lateral signal of the vehicle during turning, thereby improving the vehicle's turning performance. The electronic devices including but not limited to various onboard terminals, vehicle body controllers, etc., and can also be but not limited to various personal computers, notebook computers, smart phones, tablet computers, and portable wearable devices.

According to an exemplary embodiment, as shown in FIG. 2, the electronic device including the adaptive vehicle dynamic control device (AVDC) communicates with the controller of the current passenger vehicle, the controllers of these passenger vehicles can include, for example, the electric power steering system (EPS), the transmission control unit (TCU), the electronic stability controller (ESC), and engine management system (EMS).

In existing vehicles, wheel speed sensors, steering wheel angle sensors, accelerator pedal position sensors, and ESC are generally installed, and sensors are installed in the ESC to measure longitudinal and lateral acceleration and estimate vehicle speed and yaw acceleration. At the same time, it can be understood that in some other examples, the adaptive vehicle dynamics control device (AVDC) can be integrated into an existing vehicle controller, such as ESC or EMS.

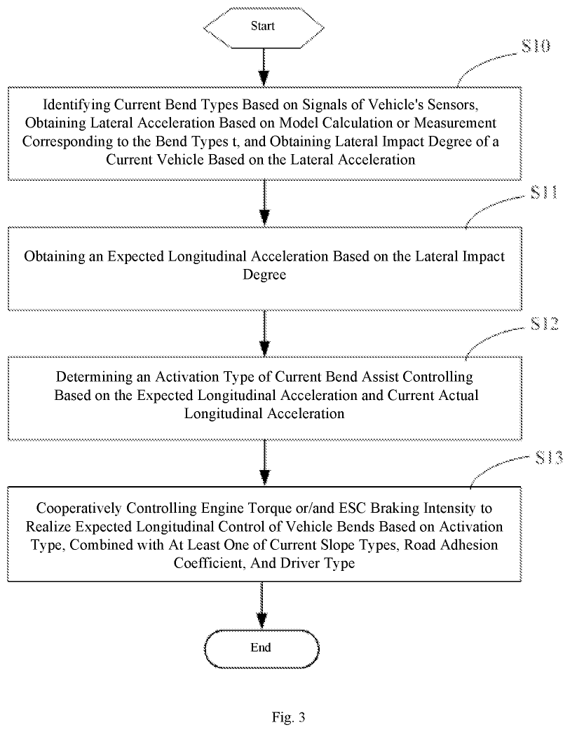

FIG. 3 is a flow chart of the self-adaptive assistance control method for vehicle passing curve provided by this application, according to an exemplary embodiment. In this embodiment, the method includes the following steps:

Step S10, identify current bend types based on signals of vehicle's sensors, obtain lateral acceleration based on model calculation corresponding to the types of the bends or based on measurement, and obtain lateral impact degree of a current vehicle based on the lateral acceleration.

Specifically, the sensors of the vehicles include but not limited to a wheel speed sensor, a steering wheel angle sensor, an accelerator pedal position sensor, and a sensor that measures longitudinal and lateral acceleration, etc.

The step S10 further includes:

Step S100, real-time detection of vehicle speed and steering wheel signals based on the sensors, obtain the first product of the steering wheel angle (SWA) and the steering wheel angular rate (SWAR), and based on the first product to determine the current bend stage, the bend stages include: bend-entering stage, bend-middle bend stage, and bend-exiting stage;

The adaptive vehicle dynamic controller detects the vehicle speed and steering wheel signals in real time, and recognizes the vehicle's turning state. The bend assists only act when exceeded a certain lateral acceleration, so it will not be activated when the vehicle speed is below than a certain threshold (for example, the vehicle speed is less than 30 km/h). The bend stages reorganization is realized by the product of the steering wheel and its derivative, for example, when SWA*SWAR is positive, it means bend-entering stage (SWA is steering wheel angle, SWAR is steering wheel angle derivative, hereinafter referred to as steering wheel angular rate), and negative means bend-exiting stage. When SWAR is within a certain threshold range, it is considered stable, however when the steering wheel just enters the steady state, the lateral acceleration of the vehicle still changes due to the hysteresis, so the reorganization of bend stages can also be combined with the lateral acceleration signal.

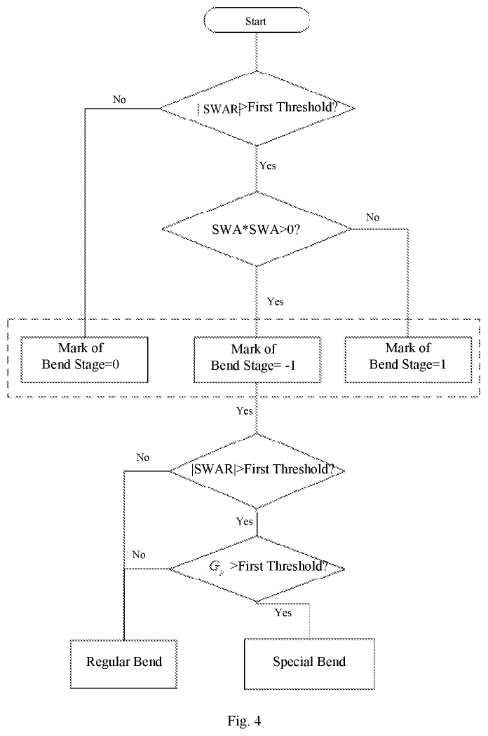

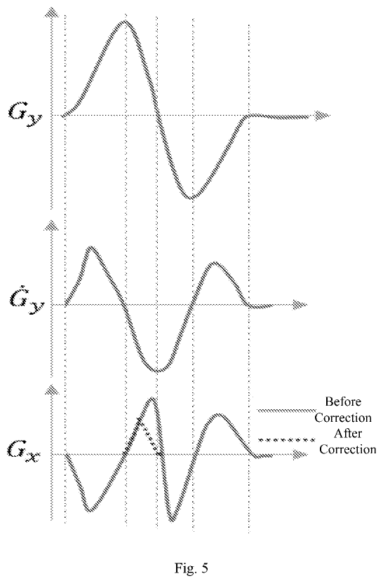

Specifically, in this embodiment, in FIG. 4, if the absolute value of the steering wheel angular rate (SWAR) is greater than or equal to the first threshold, determining that the bend stage is the bend-middle stage or the straight road stage, and setting the mark of the bend-entering stage to 0;

If the absolute value of the steering wheel angular rate is less than the first threshold, and the first product is greater than zero, determining that the bend stage is the bend-entering stage, and setting the mark of the bend-entering stage to −1;

If the absolute value of the steering wheel angular rate is less than the first threshold, and the first product is less than zero, determining that the bend stage is the bend-exiting stage, and setting the mark of the bend-exiting stage to 1.

In step 5101, in bend-entering stage (when the mark of bend stage is −1), the bend type is determined by combining the measured lateral acceleration (G_{y}), the bend types include: a regular bend and a special bend, the regular bend is a U-turn or an L-turn, and the special bend is a serpentine bend or a line shift working condition;

Specifically, in the bend-entering stage, if the measured lateral acceleration (G_{y}) is less than or equal to the second threshold value, determining that the current bend type is the regular bend; if the measured lateral acceleration (G_{y}) is greater than the second threshold value, determining that the current bend type is the special bend.

In step S102, when the current bend is the regular bend, for other long bends such as U-turn and L-turn, there are processes of entering the bend, steady-state turning and exiting the bend, the basic principle is to decelerate when entering a bend, the vehicle is at a constant speed when turning in a steady state, and to accelerate when exiting a bend. The acceleration and deceleration cannot be too large, so as not to cause discomfort to the driver during intervention. The expectation acceleration of deceleration and acceleration here also refers to the lateral jerk Ġ_{y}, however, considering the instability of the actual Ġ_{y}, the lateral acceleration Ġ_{y} is estimated by using the steering wheel angle and the vehicle speed, and then the derivation is used to obtain the lateral impact degree Ġ_{y}.

Specifically, in this embodiment:

When the current bend type is the regular bend, the lateral acceleration (G_{y}) is calculated according to the following formula:

$$\begin{matrix}r = \frac{1}{1 + A {V}^{2}} \frac{V}{l} δ & ( 2 ) \\ A = \frac{m}{{l}^{2}} ( \frac{a}{{k}_{2}} - \frac{b}{{k}_{1}} ) & ( 3 ) \\ {G}_{y} \approx V \cdot r & ( 4 )\end{matrix}$$

Where r is the yaw rate, l is the wheelbase, V is the vehicle speed, δ is the front wheel angle, and A is the stability factor;

m is the vehicle mass, a is the distance from the center of mass to the front axle, b is the distance from the center of mass to the rear axle, and k₁, k₂ are the cornering stiffness of the front and rear tires respectively;

Derivation of the lateral acceleration (G_{y}) to obtain the lateral impact degree (Ġ_{y}).

The above method of calculating the lateral acceleration does not consider the influence of the transient process of turning, for bends where transient influence are not obvious, such as U-turn and L-turn, the accuracy can be guaranteed.

When the current bend type is a special bend, for the working condition of shifting line and serpentine bend, the vehicle has only the process of entering and exiting the bend. However, in the case of serpentine and line shifting working conditions, when the vehicle quickly switches from one side of the roll to the other side, the lateral acceleration is large, and the jerk is also large in the process. Experiments have proved that under the conditions of serpentine and shifting lines working conditions, the lateral acceleration G_{y} and Ġ_{y} measured by the sensor are relatively reliable, therefore, the control variable is derived from the measured lateral acceleration.

As mentioned earlier, the lateral acceleration is obtained through the sensor measurement, and according to the lateral acceleration to obtain the lateral impact degree.

It is understandable that after obtaining the lateral impact degree, and calibrating according to formulas, calibrate the corresponding control parameters. Generally speaking, the maximum absolute value of the target acceleration for deceleration is controlled within 0.05 g. Serpentine and regular bends use different parameters, and the values of C_{xy} and T for acceleration at exit and deceleration at entry are different. At different speeds, the vehicle response is different, the parameters C_{xy} and T change with the vehicle speed to achieve better control effect.

Step S11, calculating based on the lateral impact degree to obtain an expected longitudinal acceleration;

Specifically, the step S11 includes calculating the expected longitudinal acceleration based on the following formula:

$${G}_{x} = - s g n ( {G}_{y} \cdot {\dot{G}}_{y} ) \frac{{C}_{x y}}{1 + T s} \vert {\dot{G}}_{y} \vert \qquad ( 1 )$$

Where Gₓ is the expected longitudinal acceleration, G_{y} is the lateral acceleration, Ġ_{y} is the lateral impact degree, sgn is the sign function, C_{xy} is the defined scale factor, T is the delay time, and s is the Laplace transform mark.

For working conditions such as single-shifting or serpentine, through formula (1) to calculate the sudden change in longitudinal acceleration. As shown in FIG. 1, the single-shifting line condition is switching between the first exit a bend and the second entry a bend, the value is lager, at this time, the expected longitudinal acceleration is suddenly reversed, which causes when exiting a bend and accelerating, it suddenly decelerates with a large acceleration, the method given in Literature 1 is when this working condition is detected, the predetermined deceleration when entering the bend is changed to acceleration, but this increases the under steer, and the acceleration when entering the bend is likely to cause the driver to panic. The method adopted here is that the expected acceleration when exiting a bend is not only based on Ġ_{y}, but needs to be corrected for Ġ_{y}.

When the current bend type is a special bend, the step S11 further includes the step of correcting the expected longitudinal acceleration:

When it is detected that the current lateral acceleration (G_{y}) reaches half of the maximum lateral acceleration (G_{y,max}), and it is detected that the steering wheel angular rate (SWAR) do not reach the peak value and is in the process of increasing, Then, the expected longitudinal acceleration obtained by the calculation is adjusted to achieve a reduction in proportion to the lateral acceleration G_{y}. As shown in FIG. 5, a schematic diagram of correcting the expected longitudinal acceleration is shown. After correction, the impact can be effectively reduced. Step S12, determine an activation type of current bend assist controlling based on the expected longitudinal acceleration and current actual longitudinal acceleration;

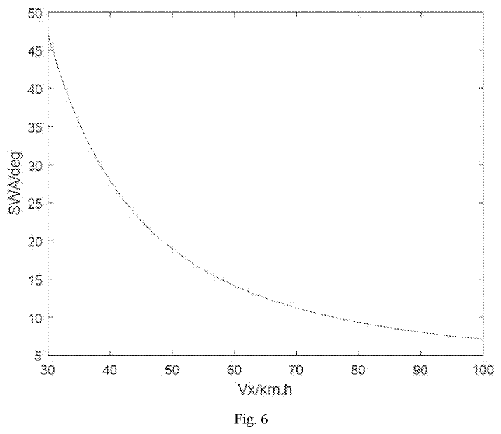

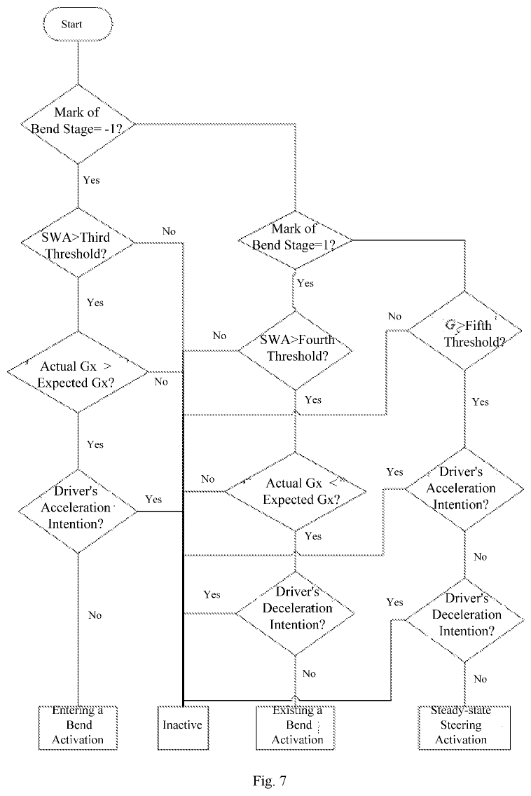

After determining the expected acceleration, it needs to determine when the bend assist control is activated. Here, using formulas (2)-(4), and considering the steering wheel angle and front wheel angle transmission ratio, the steering wheel threshold is used as the activation condition when the estimated lateral acceleration reaches 1 m/s2, as shown in FIG. 6, it can be seen that the higher the vehicle speed, the lower the steering wheel threshold.

Specifically, in this embodiment, the step S12 specifically includes:

When the current bend stage is the bend-entering stage (that is, the mark of bend stage is −1), if the steering wheel angle (SWA) is greater than the third threshold, and the expected longitudinal acceleration is greater than the current actual longitudinal acceleration, and if the driver's accelerate intention is not detected, then the activation type that triggers the current bend assist control is the bend-entering activation;

When the current bend stage is the bend-existing stage, if the steering wheel angle is greater than the fourth threshold, and the expected longitudinal acceleration is less than the current actual longitudinal acceleration, and if the driver's decelerate intention is not detected, then the activation type that triggers the current bend assist control is the bend-exiting activation; When the current bend stage is the bend-middle stage, if the lateral acceleration is greater than the fifth threshold, and if the driver's decelerate intention and accelerate intention are not detected, then the activation type that triggers the current bend assist control is the steady-state bend activation.

The deceleration intention or acceleration intention is determined by the accelerator or master cylinder pressure of the vehicle. For example, in this embodiment, the method for judging the intention to decelerate can be: if it is detected that the driver suddenly release the accelerator pedal or the master cylinder pressure reaches a certain threshold at this time, it indicates that the driver has an intention to decelerate.

Step S13, based on the activation type, combined with at least one of the current slope types, a road adhesion coefficient, and a driver type, cooperatively control the engine torque or/and the ESC braking intensity to realize the expected longitudinal control of the vehicle in the bend.

In this embodiment, the step S13 is specifically:

For the bend-entering activation, further execute the slope recognition, when current slope is recognized a downhill, realize the expected longitudinal control based on ESC braking and deceleration; when current slope is recognized a uphill, realize the expected longitudinal control based on a engine torque control;

More specifically, in this embodiment, for the activation of deceleration when entering a bend, it is necessary to determine whether to use engine torque reduction or ESC braking according to the expected deceleration; it can first determine the vehicle's deceleration when the engine torque drops to a minimum at each vehicle speed when driving straight on a level road. In a bend, according to the expected acceleration and the deceleration capacity of the engine to reduce torque to determine the operation of the actuator. The engine control adopts open-loop control because the engine torque reduction lasts for a short time, it is difficult to achieve the expected feedback control, and the torque predictive control can only be based on the model. However, this method will cause a large deviation on the slope, generally speaking, the torque of the engine into the corner may have been reduced to the minimum when going downhill, and this can only be achieved by ESC deceleration. When going uphill, the engine torque is larger, and the deceleration ability is stronger. Therefore, slope recognition is adopted. The basic principle of the method adopted is to obtain the longitudinal acceleration through the vehicle speed derivation, and the longitudinal acceleration measured by ESC has a vector along the slope, and the slope is estimated by the offset of the two longitudinal accelerations. According to different working conditions, adopt model-based engine torque predictive control, when the deceleration capacity exceeds the engine torque reduction, ESC is used to control deceleration. The ESC deceleration control here controls the brake fluid through a solenoid valve to increase the wheel cylinder pressure and push the caliper to brake, however, for vehicle control, ESC generally comes from a supplier, the supplier provides a control interface for the overall deceleration of the vehicle, if the pressure of each wheel cylinder can be controlled independently, a better turning assistance control effect can be achieved.

For the steady-state steering activation, based on the engine torque state and the current longitudinal acceleration, using feedback control, and based on controlling the engine torque or ESC braking to control the vehicle to drive at a constant speed.

More specifically, for the steady-state steering activation, the control target position of the longitudinal acceleration of the vehicle is 0, and using the method of feedback control, based on the engine torque state and the current longitudinal acceleration, the engine noise will be significantly increased, and the torque will not be increased. If the vehicle is on a downhill slope, and the engine torque is even at the lowest, at this time, a braking request is made to the ESC to control the constant speed driving.

For the bend-exiting activation, based on the expected longitudinal acceleration and the current longitudinal acceleration, the current engine torque is increased to achieve the expected longitudinal control.

More specifically, for the bend-exiting activation, because the engine torque increase is relatively slow, using model-based open-loop control, according to the expected longitudinal acceleration and current longitudinal acceleration, the current engine torque is increased to a certain extent, the increase in torque is controlled so as not to cause a significant increase in engine noise, and during the increase in torque, the transmission does not shift gears.

The step S13 further includes:

Based on the relationship between tire slipping and the longitudinal acceleration of the vehicle to estimate the road adhesion coefficient, and based on the estimated road adhesion coefficient, obtain the control parameters corresponding to the road adhesion coefficient, that is, the scale factor C_{xy} and the delay time T, using the formula one to obtain the latest expected longitudinal acceleration Gₓ; or/and

Recognizing the driver's style and ability to obtain the scale factor C_{xy} and the delay time T corresponding to the driver's style and ability, and using the formula one to obtain the latest expected longitudinal acceleration Gₓ. For example, in some examples, the driver's style is defined as conservative and aggressive, and the driver's ability is defined as novice and proficient. For drivers with different driving abilities and styles, adopt different control parameters (including scale factor C_{xy} and delay time T), to achieve the effect of human-vehicle integration and achieve good bend assistance performance.

It is understandable that, in this embodiment, it further includes: A large number of experiments are used to pre-calibrate the control parameters of the entering and exiting stages corresponding to various working conditions, each road adhesion coefficient, each driver's style and ability, that is, the scale factor C_{xy} and the delay time T.

As shown in FIG. 8, in another aspect of the present disclosure, a self-adaptive assistance control device for vehicle passing curve 1 is also provided, the device includes a preprocessing unit 10, an expected longitudinal acceleration obtaining unit 11, an activation type determination unit 12, and a longitudinal control processing unit 13.

The preprocessing unit 10 is configured to identify types of bends based on signals of vehicle's sensors, obtain lateral acceleration based on model calculation corresponding to the types of the bends or based on measurement, and obtain lateral impact degree of a current vehicle based on the lateral acceleration;

The expected longitudinal acceleration obtaining unit 11, configured to obtain an expected longitudinal acceleration based on the lateral impact degree;

The activation type determining unit 12, configured to determine an activation type of current bend assist controlling based on the expected longitudinal acceleration and current actual longitudinal acceleration;

The longitudinal control processing unit 13, configured to cooperatively control engine torque or/and ESC braking intensity to realize expected longitudinal control of vehicle bends based on the activation type, combined with at least one of current slope types, a road adhesion coefficient, and a driver type.

In an example, the device 1 is integrated in an independent device (such as a vehicle-onboard terminal or a vehicle-onboard controller), it is connected with the electric power steering system, gearbox controller, body stability control system, and engine controller of the vehicle; or, in other examples, the device 1 can be integrated into an existing vehicle onboard controller, for example, it is integrated into the existing electric power steering system or body stability control system.

In one of the embodiments, the preprocessing unit 10 may also be configured to detect vehicle speed and steering wheel signals in real time, obtain the first product of the steering wheel angle (SWA) and the steering wheel angular rate (SWAR), determine the current bend stage based on the first product, the bend stage includes: bend-entering stage, bend-middle stage, and bend-exiting stage; In the bend-entering stage, combine the measured lateral acceleration (G_{y}) to determine the type of bend, the bend types include: a regular bend and a special bend, the regular bend is a U-turn or an L-turn, and the special bend is a serpentine bend or a line shift working condition; when the current bend type is a regular bend, based on the steady-state steering approximation model to calculate and obtain the lateral acceleration, and based on the lateral acceleration to obtain the lateral impact degree; when the current bend type is a special bend, the lateral acceleration is measured by the sensors, and based on the lateral acceleration to obtain the lateral impact degree.

In one of the embodiments, the expected longitudinal acceleration obtaining unit 11 can also be configured to calculate the expected longitudinal acceleration through the following formula:

$${G}_{x} = - s g n ( {G}_{y} \cdot {\dot{G}}_{y} ) \frac{{C}_{x y}}{1 + T s} \vert {\dot{G}}_{y} \vert \qquad ( 1 )$$

Where Gₓ is the expected longitudinal acceleration, G_{y} is the lateral acceleration, Ġ_{y} is the lateral impact degree, sgn is the sign function, C_{xy} is the defined scale factor, T is the delay time, and s is the Laplace transform mark;

And when the current bend is the special bend, it further includes correcting the expected longitudinal acceleration.

When the current bend type is a special bend, further comprising the step of correcting the expected longitudinal acceleration.

In one of the embodiments, the activation type determining unit 12 may also be configured to further execute the slope recognition in the bend-entering activation, when current slope is recognized a downhill, realize the expected longitudinal control based on ESC braking and deceleration; when current slope is recognized a uphill, realize the expected longitudinal control based on a engine torque control; for the steady-state steering activation, to control the vehicle to drive at a constant speed based on an engine torque or ESC braking control, the engine torque or ESC braking control based on engine torque states and current longitudinal acceleration feedback; for the bend-exiting activation, to realize the expected longitudinal control based on increasing engine torque, increasing engine torque based on the expected longitudinal acceleration and current longitudinal acceleration.

It can be understood that for the specific definition of the self-adaptive assistance control device for vehicle passing curve, please refer to the explanation of the self-adaptive assistance control method for vehicle passing curve in the above, which will not be repeated here. All or part of the units in the adaptive vehicle curve auxiliary control device can be realized by software, hardware and their combination. The above units can be embedded in or independent of the processor in the computer device in the form of hardware, and can also be stored in the memory in the form of software, so that the processor can call and execute the corresponding operations of the above units.

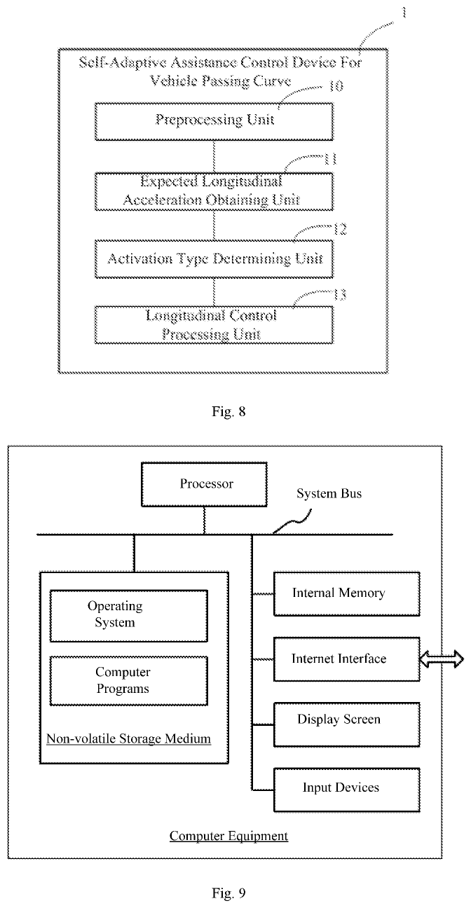

Correspondingly, according to another aspect of the application, a computer device is provided, the computer device can be a vehicle terminal or a vehicle controller, and its internal structure diagram can be as shown in FIG. 9. The computer device includes processor, memory, network interface, display screen and input device connected through system bus. The processor of the computer device is used to provide computing and control capabilities. The memory of the computer device comprises a nonvolatile storage medium and an internal memory. The nonvolatile storage medium stores an operating system and computer programs. The memory provides environment for operating system and computer programs in nonvolatile storage medium. The network interface of the computer device is used to communicate with the external terminal through network. When the computer program is executed by the processor, a self-adaptive assistance control method for vehicle passing curve is realized. The display screen of the computer device can be a liquid crystal display or an electronic ink display screen, and the input device of the computer device can be a touch layer covered on the display screen, a key, a trackball or a touch board set on the shell of the computer device, or an external keyboard, a touch board or a mouse.

It can be understood by those skilled in the art that the structure shown in FIG. 9 is only a block diagram of a part of the structure related to the application, and does not have a limitation on the computer device to which the application is applied. The specific computer device may include more or less components than those shown in FIG. 9, or combine some components, or have different component arrangements.

In one embodiment, a computer device includes a memory, a processor and computer programs stored on the memory, the computer programs can be run on the processor. The processor implements the following steps when executing the computer programs:

Identify current bend types based on signals of vehicle's sensors, obtain lateral acceleration based on model calculation or measurement corresponding to the bend types, and obtain lateral impact degree of a current vehicle based on the lateral acceleration;

Obtain an expected longitudinal acceleration based on the lateral impact degree;

Determining an activation type of current bend assist controlling based on the expected longitudinal acceleration and current actual longitudinal acceleration; and

Cooperatively controlling engine torque or/and ESC braking intensity to realize expected longitudinal control of vehicle bends based on the activation type, combined with at least one of current slope types, a road adhesion coefficient, and a driver type.

Correspondingly, another aspect of the disclosure also provides a computer-readable storage medium on which computer programs are stored. When the computer programs are executed by a processor, the following steps will be realized:

Identify current bend types based on signals of vehicle's sensors, obtain lateral acceleration based on model calculation or measurement corresponding to the bend types, and obtain lateral impact degree of a current vehicle based on the lateral acceleration;

Obtain an expected longitudinal acceleration based on the lateral impact degree;

Determining an activation type of current bend assist controlling based on the expected longitudinal acceleration and current actual longitudinal acceleration; and

Cooperatively controlling engine torque or/and ESC braking intensity to realize expected longitudinal control of vehicle bends based on the activation type, combined with at least one of current slope types, a road adhesion coefficient, and a driver type.

It can be understood that for more details of the steps involved in the above computer device and computer-readable storage medium, reference can be made to the above-mentioned limitation on the self-adaptive assistance control method for vehicle passing curve, which will not be repeated here.

Any reference to memory, storage, database or other media used in the embodiments provided by the application may include non-volatile and/or volatile memory. Non-volatile memory includes read-only memory (ROM), programmable ROM (PROM), electrically programmable ROM (EPROM), electrically erasable programmable ROM (EEPROM) or flash memory. The volatile memory includes random access memory (RAM) or external cache memory. As an illustration, rather than a limitation, RAM can be in many forms. Such as static RAM (SRAM), dynamic RAM (DRAM), synchronous DRAM (SDRAM), dual data rate SDRAM (DDRSDRAM), enhanced SDRAM (ESDRAM), Synchlink, DRAM (SLDRAM), Rambus direct RAM (RDRAM), direct rambus dynamic RAM (DRDRAM), and Rambus dynamic RAM (RDRAM).

In summary, the embodiments of the disclosure have the following beneficial effects.

Through the self-adaptive assistance method for vehicle passing curve, device, computer device and storage medium provided by the application, the driver's manipulation intention can be analyzed based on the sensors of the vehicle, the steering wheel signals, accelerator and brake pedal signals. In the turning process, a certain longitudinal control is implemented based on the lateral signal of the vehicle, in order to improve the turning performance.

In the embodiments of the disclosure, based on the model and the measured lateral acceleration, the problem of excessive fluctuation of lateral impact degree is effectively solved; ensuring the control performance of each working condition based on driving conditions (curve type, ramp, road adhesion coefficient) and driver type identification and appropriate control parameters, control parameters selected based on working conditions and driver types. Detect the driver's driving intention to achieve a good integration of system intervention and driver control, control system intervention intensity so as not to cause discomfort of the driver during intervention. The model-based feed forward control method is used to coordinate the engine and ESC to alleviate the delay of the controller and achieve the expected longitudinal acceleration control. Through the above ways, the driver can feel more easily, comfortably and safely.

In the embodiment of the present disclosure, without increasing the hardware and cost of the vehicle, a certain bend assist control is performed on the vehicle to realize the adaptive control of different driving conditions and the driver's cornering, and improve the vehicle's cornering controllability, comfort and stability.

The above disclosure is only better embodiments, which cannot be used to limit the protection scope of the disclosure. Therefore, the equivalent changes made according to the claims of the disclosure still belong to the protection scope of the disclosure.

1. A self-adaptive vehicle bend assistance control method for vehicle passing curve, comprising:
step S10, identifying current bend types based on signals of vehicle's sensors, obtaining lateral acceleration based on model calculation or measurement corresponding to the bend types, and obtaining lateral impact degree of a current vehicle based on the lateral acceleration;
step S11, obtaining an expected longitudinal acceleration based on the lateral impact degree calculation;
step S12, determining an activation type of current bend assist controlling based on the expected longitudinal acceleration and current actual longitudinal acceleration; and
step S13, cooperatively controlling engine torque or/and ESC braking intensity to realize expected longitudinal control of vehicle bends based on the activation type, combined with at least one of current slope types, a road adhesion coefficient, and a driver type.

2. The method of claim 1, wherein the step S10 further comprises:
step S100, obtaining a first product of a steering wheel angle (SWA) and a steering wheel angular rate (SWAR) based on real-time detection of the vehicle speed and steering wheel signals, and determining a current bend stage based on the first product, wherein bend stages include: bend-entering stage, bend-middle stage, and bend-exiting stage;
step S101, when the bend stage is the bend-entering stage, determining the bend type based on the measured lateral acceleration (G_{y}), wherein the bend types include a regular bend and a special bend, wherein the regular bend is a U-turn or an L-turn, wherein the special bend is a serpentine bend or a line shift working condition;
step S102, when the bend type is the regular bend, obtaining the lateral acceleration based on a steady-state steering approximate model, and obtaining the lateral impact degree based on the lateral acceleration;
when the bend type is the special bend, obtaining the lateral acceleration based on vehicle's sensors, and obtaining the lateral impact degree based on the lateral acceleration.

3. The method of claim 2, wherein the step S100 comprises:
determining that the bend stage is bend-middle stage or a straight road stage if an absolute value of steering wheel angular rate is greater than or equal to a first threshold;
determining that the bend stage is the bend-entering stage if the absolute value of steering wheel angular rate is less than the first threshold and the first product is greater than zero;
determining that the bend stage is the bend-exiting stage if the absolute value of the steering wheel angular rate is less than the first threshold, and the first product is less than zero.

4. The method of claim 3, wherein step S101 comprises:
in the bend-entering stage, determining the current bend type is the regular bend if a measured lateral acceleration (G_{y}) is less than or equal to a second threshold; and determining the current bend type is the special bend if the measured lateral acceleration is greater than the second threshold.

5. The method of claim 4, wherein the step S102 comprises:
If the current bend type is the regular bend, the lateral acceleration (G_{y}) is calculated based on the following formula:
$$\begin{matrix}r = \frac{1}{1 + A {V}^{2}} \frac{V}{l} δ & ( 2 ) \\ A = \frac{m}{{l}^{2}} ( \frac{a}{{k}_{2}} - \frac{b}{{k}_{1}} ) & ( 3 ) \\ {G}_{y} \approx V \cdot r & ( 4 )\end{matrix}$$
wherein r is yaw rate, l is wheelbase, V is vehicle speed, δ is front wheel angle, and A is stability factor;
m is vehicle mass, a is distance from center of mass to front axle, b is distance from center of mass to rear axle, and k₁, k₂ are cornering stiffness of front and rear tires respectively;
obtaining the lateral impact degree (Ġ_{y})) based on derivate of the lateral acceleration (G_{y}).

6. The method of claim 5, wherein the step S11 comprises calculating the expected longitudinal acceleration based on the following formula:
$${G}_{x} = - s g n ( {G}_{y} \cdot {\dot{G}}_{y} ) \frac{{C}_{x y}}{1 + T s} \vert {\dot{G}}_{y} \vert \qquad ( 1 )$$
wherein Gₓ is the expected longitudinal acceleration, G_{y} is the lateral acceleration, Ġ_{y} is the lateral impact degree, sgn is a sign function, C_{xy} is a defined
scale factor, T is a delay time, and s is Laplace transform mark.

7. The method of claim 6, wherein when the current bend type is the special bend, the step S11 further comprises the step of correcting the expected longitudinal acceleration:
adjusting the expected longitudinal acceleration obtained by calculation, to achieve a reduction in same proportion with the lateral acceleration G_{y}, if it is detected that the current lateral acceleration (G_{y}) reaches a half of maximum lateral acceleration (G_{y,max}), and it is detected that the steering wheel angular rate (SWAR) do not reach a peak value and is in the process of increasing.

8. The method of claim 1, wherein the step S12 comprises:
when the current bend stage is the bend-entering stage, triggering a bend-entering activation of current bend assist control activation types if the steering wheel angle is greater than a third threshold, the expected longitudinal acceleration is greater than current actual longitudinal acceleration, and a driver's accelerate intention is not detected;
when the current bend stage is the bend-exiting stage, triggering a bend-exiting activation of current bend assist control activation types if the steering wheel angle is greater than a fourth threshold, the expected longitudinal acceleration is less than current actual longitudinal acceleration, and a driver's decelerate intention is not detected;
when the current bend stage is the bend-middle stage, triggering a steady-state bend activation of current bend assist control activation types if the lateral acceleration is greater than a fifth threshold, and driver's decelerate intention and accelerate intention are not detected;
wherein the deceleration intention or the acceleration intention is determined by the accelerator or master cylinder pressure of the vehicle.

9. The method of claim 8, wherein the step S13 comprises:
for the bend-entering activation, further executing the slope recognition, when current slope is recognized a downhill, realizing the expected longitudinal control based on ESC braking and deceleration; when current slope is recognized a uphill, realizing the expected longitudinal control based on a engine torque control;
for the steady-state steering activation, controlling the vehicle to drive at a constant speed through an engine torque or ESC braking control by adopting a feedback controlling means, based on engine torque states and current longitudinal acceleration feedback;
for the bend-exiting activation, performing torque-increasing processing to realize the expected longitudinal control, based on the expected longitudinal acceleration and current longitudinal acceleration.

10. The method of claim 9, wherein the step S13 further comprises:
estimating a road adhesion coefficient based on relationships between tire
slipping and the longitudinal acceleration of the vehicle, obtaining the scale factor C_{xy} and the delay time T corresponding to the road adhesion coefficient, and obtaining a latest expected longitudinal acceleration Gₓ based on formula one; or/and
recognizing a driver's style and a driver's ability, obtaining the scale factor C_{xy} and the delay time T corresponding to the driver's style and the driver's ability, and obtaining a latest expected longitudinal acceleration Gₓ based on formula one.

11. The method of claim 10, the step S13 further comprises: pre-calibrating the control parameters of the entering a bend stage and of the exiting a bend stage corresponding to various working conditions, each road adhesion coefficient, each driver's style and driver's ability, wherein the control parameters include the scale factor C_{xy} and the delay time T.

12. (canceled)

13. (canceled)

14. A computer device, comprising: a memory, a processor and computer programs stored in the memory can be executed by the processor, wherein the processor executes the computer programs to realize steps of a self-adaptive assistance control method for vehicle passing curve, the method comprising:
step S10, identifying current bend types based on signals of vehicle's sensors, obtaining lateral acceleration based on model calculation or measurement corresponding to the bend types, and obtaining lateral impact degree of a current vehicle based on the lateral acceleration;
step S11, obtaining an expected longitudinal acceleration based on the lateral impact degree;
step S12, determining an activation type of current bend assist controlling based on the expected longitudinal acceleration and current actual longitudinal acceleration; and
step S13, cooperatively controlling engine torque or/and ESC braking intensity to realize expected longitudinal control of vehicle bends based on the activation type, combined with at least one of current slope types, a road adhesion coefficient, and a driver type.

15. A computer-readable storage medium, on which computer programs are stored, when the computer programs are executed by a processor, steps of a self-adaptive assistance control method for vehicle passing curve are performed, the method comprising:
step S10, identifying current bend types based on signals of vehicle's sensors, obtaining lateral acceleration based on model calculation or measurement corresponding to the bend types, and obtaining lateral impact degree of a current vehicle based on the lateral acceleration;
step S11, obtaining an expected longitudinal acceleration based on the lateral impact degree;
step S12, determining an activation type of current bend assist controlling based on the expected longitudinal acceleration and current actual longitudinal acceleration; and
step S13, cooperatively controlling engine torque or/and ESC braking intensity to realize expected longitudinal control of vehicle bends based on the activation type, combined with at least one of current slope types, a road adhesion coefficient, and a driver type.

16. The device of claim 14, wherein the device is a separate device which can communicates with electric power steering system, transmission control unit, electronic stability controller and engine management system; or
the device can be integrated into the electric power steering system or electronic stability controller.

17. The device of claim 14, wherein the step S10 further comprises:
step S100, obtaining a first product of a steering wheel angle (SWA) and a steering wheel angular rate (SWAR) based on real-time detection of the vehicle speed and steering wheel signals, and determining a current bend stage based on the first product, wherein bend stages include: bend-entering stage, bend-middle stage, and bend-exiting stage;
step S101, when the bend stage is the bend-entering stage, determining the bend type based on the measured lateral acceleration (G_{y}), wherein the bend types include a regular bend and a special bend, wherein the regular bend is a U-turn or an L-turn, wherein the special bend is a serpentine bend or a line shift working condition;
step S102, when the bend type is the regular bend, obtaining the lateral acceleration based on a steady-state steering approximate model, and obtaining the lateral impact degree based on the lateral acceleration;
when the bend type is the special bend, obtaining the lateral acceleration based on vehicle's sensors, and obtaining the lateral impact degree based on the lateral acceleration.

18. The device of claim 17, wherein the step S100 comprises:
determining that the bend stage is bend-middle stage or a straight road stage if an absolute value of steering wheel angular rate is greater than or equal to a first threshold;
determining that the bend stage is the bend-entering stage if the absolute value of steering wheel angular rate is less than the first threshold and the first product is greater than zero;
determining that the bend stage is the bend-exiting stage if the absolute value of the steering wheel angular rate is less than the first threshold, and the first product is less than zero.

19. The device of claim 18, wherein step S101 comprises:
in the bend-entering stage, determining the current bend type is the regular bend if a measured lateral acceleration (G_{y}) is less than or equal to a second threshold; and determining the current bend type is the special bend if the measured lateral acceleration is greater than the second threshold.

20. The device of claim 14, wherein the step S12 comprises:
when the current bend stage is the bend-entering stage, triggering a bend-entering activation of current bend assist control activation types if the steering wheel angle is greater than a third threshold, the expected longitudinal acceleration is greater than current actual longitudinal acceleration, and a driver's accelerate intention is not detected;
when the current bend stage is the bend-exiting stage, triggering a bend-exiting activation of current bend assist control activation types if the steering wheel angle is greater than a fourth threshold, the expected longitudinal acceleration is less than current actual longitudinal acceleration, and a driver's decelerate intention is not detected;
when the current bend stage is the bend-middle stage, triggering a steady-state bend activation of current bend assist control activation types if the lateral acceleration is greater than a fifth threshold, and driver's decelerate intention and accelerate intention are not detected;
wherein the deceleration intention or the acceleration intention is determined by the accelerator or master cylinder pressure of the vehicle.

21. The device of claim 20, wherein the step S13 comprises:
for the bend-entering activation, further executing the slope recognition, when current slope is recognized a downhill, realizing the expected longitudinal control based on ESC braking and deceleration; when current slope is recognized a uphill, realizing the expected longitudinal control based on a engine torque control;
for the steady-state steering activation, controlling the vehicle to drive at a constant speed through an engine torque or ESC braking control by adopting a feedback controlling means, based on engine torque states and current longitudinal acceleration feedback;
for the bend-exiting activation, performing torque-increasing processing to realize the expected longitudinal control, based on the expected longitudinal acceleration and current longitudinal acceleration.

22. The device of claim 21, wherein the step S13 comprises:
estimating a road adhesion coefficient based on relationships between tire slipping and the longitudinal acceleration of the vehicle, obtaining the scale factor C_{xy} and the delay time T corresponding to the road adhesion coefficient, and obtaining a latest expected longitudinal acceleration Gₓ based on formula one; or/and
recognizing a driver's style and a driver's ability, obtaining the scale factor C_{xy} and the delay time T corresponding to the driver's style and the driver's ability, and obtaining a latest expected longitudinal acceleration Gₓ based on formula one.
